(19) United States
(12) Patent Application Publication
(10) Pub. No.: US 2012/0178418 A1
(43) Pub. Date: Jul. 12, 2012

(54) Method and System for Changing a Selected Home Operator of a Machine to Machine Equipment

(75) Inventor: Wantao Yu, Shenzhen (CN)

(73) Assignee: ZTE CORPORATION, Shenzhen City, Guangdong Province (CN)

(21) Appl. No.: 13/395,881

(22) PCT Filed: Mar. 30, 2010
(86) PCT No.: PCT/CN2010/071401

§ 371 Date: Mar. 13, 2012

(30) Foreign Application Priority Data
Sep. 14, 2009 (CN) 200910173202.5

(51) Int. Cl. H04W 12/06; H04W 60/00; H04W 76/02

(52) U.S. Cl. 455/411; 455/418

(57) ABSTRACT

A method and system for changing a SHO of a M2ME are provided. The method includes: mode one: a new SHO receiving parameters of the M2ME, after the M2ME passes the verification by a PVA, providing a MCIM of the new SHO to the M2ME through a connection between the M2ME and a RO provided by an old SHO; and the M2ME installs the new MCIM in a UICC; or, mode two: a new SHO receiving parameters of the M2ME, after the M2ME passes the verification by a PVA, providing a MCIM of the new SHO to the M2ME through a connection between the M2ME and a RO established by a TRE functional entity; and the M2ME installs the new MCIM in a UICC; and both the UICC and the TRE functional entity are located in the M2ME. The present invention is able to change the SHO of the M2ME.

### TECHNICAL FIELD

The present invention relates to an M2M (Machine to Machine) communication technology, and particularly, to a method and system for changing a Selected Home Operator (SHO) of a Machine to Machine Equipment (M2ME).

### BACKGROUND OF THE RELATED ART

The M2M communication is a generic term of a series of techniques and combinations thereof which is used to realize data communication and intercommunication between machines and between the machine and human by applying a wireless communication technology. The M2M has two meanings: one is that, for the machine itself, the machine is referred to as a smart equipment in the embedded field; the second meaning is the connection between the machines, that is, the machines are connected together through the network. The application range of the machine-type communication is very wide, such as intelligent measurement, remote monitoring, tracking and medical, and so on, so as to make human life more intelligent. Compared with the traditional communication between peoples, the number of M2MEs (Machine to Machine Equipment) is huge, the application field is wide, and the market prospect is also huge.

In the M2M communication, the main long-distance connectivity technologies comprise GSM/GPRS/UMTS, and the short-distance connectivity technologies mainly comprise 802.11b/g, Bluetooth, Zigbee, RFID, and so on. The M2M belongs to a service for equipments. Since the M2M integrates the wireless communication and information technology, it can be used for two-way communication, such as long-distance collecting information, setting parameters and sending instructions, so as to realize different application solutions, such as security monitoring, auto sales, cargo tracking, and so on. Almost all equipments involved in the daily life are likely to be potential service objects. The M2M provides a simple means for establishing a wireless connection of equipment real-time data between systems, remote equipments, or individuals.

A challenge of the M2M communication is a remote security management of the deployed M2M equipments. For this purpose, we need to solve how to remotely provide subscription data, i.e., MCIM (Machine Communication Identity Module) to the M2ME and to prevent the MCIM from being obtained and used by a attacker in the provisioning process. The MCIM application is a group of M2M security data and functions for accessing the 3GPP network (which might also be the IMS network). The MCIM can be located in a UICC (Universal Integrated Circuit Card), or a TRE (The Trusted environment) functional entity. When the MCIM is located in the UICC, the MCIM refers to a USIM (Universal Subscriber Identity Module) or an ISIM (IP Multimedia Services Identity Module). The TRE functional entity refers to a trusted environment functional entity provided by the M2ME, and one TRE functional entity can be verified by an authorized external proxy at any time if needed. The MCIM can be installed in the TRE functional entity, and the M2ME provides hardware and software protection and isolation for the MCIM through the TRE functional entity.

At present, the M2ME provides the M2M services usually by two ways: based on the UICC or based on the TRE functional entity.

When the M2ME provides the M2M services based on the UICC, there are two solutions for how to remotely change the subscription data, that is, change the selected home operator of the M2M equipment:

1. the solution in which the subscription data cannot be remotely changed: this solution can conveniently provide the M2M services to the M2ME, whereas, when the M2M service subscriber wants to change the operator of the M2M service, the UICC must be replaced, which makes the M2ME maintenance very difficult, and even if it is possible, it is very costly; thus this solution cannot realize the MCIM remote management for the M2ME;

2. the solution in which the subscription data can be remotely changed: if the selected home operator is determined when the UICC is issued, this solution does not have the problem of initial providing of the MCIM; however, if the selected home operator is determined after the UICC is issued, initially providing the MCIM to the UICC is a problem to be solved; in addition, this solution changes the operator by changing the IMSI (International Mobile Subscriber Identity), and although it can be conveniently to manage the M2ME, this solution relates to the IMSI transferring between different mobile operators' networks, thereby increasing the security risk of the subscription data of the M2ME; and meanwhile, in the process of changing the IMSI, the UICC might break its connection with any operator.

When the M2ME provides the M2M services based on the TRE functional entity, the MCIM provided remotely is installed in the TRE functional entity through the initial connection provided by the TRE functional entity. Its drawback is that protection for the MCIM depends on the security of the TRE functional entity. Since the TRE functional entity is realized in the M2ME, the security of the TRE functional entity is lower than the UICC; thus the security of the MCIM in the TRE functional entity is not high. The problem of the solution of changing the selected home operator of the M2M equipment based on the TRE function entity is still in that: the security of the MCIM is hard to be guaranteed after the MCIM is provided to the TRE functional entity.

### CONTENT OF THE INVENTION

The technical problem to be solved in the present invention is to provide a method and system for changing a selected home operator of an M2M equipment, which combines a TRE functional entity and a UICC to realize changing the selected home operator of the M2ME.

In order to solve the aforementioned technical problem, the present invention provides a method for changing a selected home operator of a machine to machine (M2M) equipment, comprising:

mode one: a new selected home operator (SHO) receiving parameters of a machine to machine equipment (M2ME), and after verifying the M2ME by a platform validation authority center (PVA) and the M2ME passes the verification, providing a machine communication identity module (MCIM) of the new SHO to the M2ME by a connection between the M2ME and a registration operator (RO) provided by an old SHO; and the M2ME installing the new MCIM in a universal integrated circuit card (UICC); or,

mode two: a new SHO receiving parameters of an M2ME, and after verifying the M2ME by a PVA and the M2ME passes the verification, providing an MCIM of the new SHO to the M2ME through a connection between the M2ME and a RO established by a trusted environment (TRE) functional entity; and the M2ME installing the new MCIM in a UICC;

wherein, both the UICC and the TRE functional entity are located in the M2ME.

In the mode one, the step of the new SHO receiving the parameters of the M2ME and providing the MCIM to the M2ME comprises:

an M2ME subscriber sending the parameters of the M2ME to the new SHO, and notifying the M2ME to execute an MCIM re-provisioning;

the new SHO, after verifying the M2ME by the PVA and the M2ME passes the verification, sending the MCIM of the new SHO to the RO;

the RO sending the new MCIM to the M2ME through the connection provided by the old SHO.

The aforementioned method can also have the following feature:

after performing the step of the RO sending the new MCIM to the M2ME, and before performing the step of the M2ME installing the new MCIM in the UICC, a step further performed is:

the M2ME deleting information of the old SHO in the M2ME, wherein the information of the old SHO comprises the MCIM of the old SHO.

In the mode two, the step of the new SHO receiving the parameters of the M2ME and providing the MCIM to the M2ME comprises:

an M2ME subscriber sending the parameters of the M2ME to the new SHO, and notifying the M2ME to execute an MCIM re-provisioning, and, sending information of the new SHO and the parameters of the M2ME to the RO;

the RO activating the TRE functional entity in the M2ME;

the M2ME establishing the connection with the RO through the TRE functional entity, and the RO registering the M2ME in the new SHO;

the new SHO, after verifying the M2ME by the PVA and the M2ME passes the verification, authorizing the RO to provide the MCIM of the new SHO;

the RO sending the new MCIM to the M2ME through the connection established by the TRE functional entity.

The aforementioned method can also have the following feature:

after performing the step of the RO activating the TRE functional entity in the M2ME and before performing the step of the M2ME establishing the connection with the RO through the TRE functional entity, a step further performed is: the M2ME deleting information of the old SHO in the M2ME; or,

after performing the step of the RO sending the new MCIM to the M2ME and before performing the step of the M2ME installing the new MCIM in the UICC, a step further performed is: the M2ME deleting information of the old SHO in the M2ME;

wherein, the information of the old SHO comprises the MCIM of the old SHO.

In the mode two, the step of the new SHO receiving the parameters of the M2ME and providing the MCIM to the M2ME comprises:

an M2ME subscriber sending the parameters of the M2ME to the new SHO, and notifying the M2ME to execute an MCIM re-provisioning, and, sending information of the new SHO and the parameters of the M2ME to the RO;

the RO notifying the old SHO that the M2ME changes the SHO;

the old SHO activating the TRE functional entity in the M2ME through an over the air (OTA) mode;

the M2ME establishing the connection with the RO through the TRE functional entity, and the RO registering the M2ME in the new SHO;

the new SHO, after verifying the M2ME by the PVA and the M2ME passes the verification, authorizing the RO to provide the MCIM of the new SHO;

the RO sending the new MCIM to the M2ME through the connection established by the TRE functional entity.

In the mode two, the step of the new SHO receiving the parameters of the M2ME and providing the MCIM to the M2ME comprises:

an M2ME subscriber sending the parameters of the M2ME to the new SHO, and notifying the M2ME to execute an MCIM re-provisioning, and, sending information of the new SHO and the parameters of the M2ME to the old SHO;

the old SHO activating the TRE functional entity in the M2ME through an over the air (OTA) mode;

the M2ME establishing the connection with the RO through the TRE functional entity, and the RO registering the M2ME in the new SHO;

the new SHO, after verifying the M2ME by the PVA and the M2ME passes the verification, authorizing the RO to provide the MCIM of the new SHO;

the RO sending the new MCIM to the M2ME through the connection established by the TRE functional entity.

The aforementioned method can also have the following feature:

in the step of the old SHO activating the TRE functional entity in the M2ME, the old SHO further deletes information of the old SHO in the M2ME at the same time; or,

after performing the step of the RO sending the new MCIM to the M2ME and before performing the step of the M2ME installing the new MCIM in the UICC, a step further performed is: the M2ME deleting information of the old SHO in the M2ME;

wherein, the information of the old SHO comprises the MCIM of the old SHO.

The aforementioned method can also have the following feature:

the step of the M2ME establishing the connection with the RO through the TRE functional entity and the RO registering the M2ME in the new SHO comprises:

the M2ME establishing an initial connection with a randomly selected visited network operator (VNO) through the TRE functional entity;

the VNO contacting with the RO, and sending a provisional connectivity identity (PCID) received from the M2ME to the RO;

the RO generating a set of authentication vectors regarding to the PCID, and sending to the VNO;

the VNO authenticating the PCID and the M2ME by using the authentication vectors, and after the authentication is passed, the VNO providing the M2ME with an IP connection to the RO;

the M2ME contacting with the RO through the IP connection provided by the VNO;

the RO discovering the new SHO for the M2ME, or, the M2ME discovering the new SHO through the RO;

the RO connecting with the new SHO, and registering the M2ME in the new SHO.

In order to solve the aforementioned technical problem, the present invention provides a system for changing a selected home operator of a machine to machine (M2M) equipment, comprising: a machine to machine equipment (M2ME), a new selected home operator (SHO), an old SHO, a platform validation authority center (PVA) and a registration operator (RO), wherein:

the new SHO is configured to, receive parameters of the M2ME, and after verifying the M2ME by the PVA and the M2ME passes the verification, provide an MCIM of the new SHO to the M2ME through a connection between the M2ME and the RO provided by the old SHO or through a connection between the M2ME and the RO established by a trusted environment (TRE) functional entity;

the M2ME is configured to install the new MCIM in a universal integrated circuit card (UICC);

wherein, both the UICC and the TRE functional entity are located in the M2ME.

The aforementioned system can also have the following feature:

the new SHO is further configured to send the MCIM of the new SHO to the RO after verifying the M2ME by the PVA and the M2ME passes the verification;

the RO is configured to send the new MCIM to the M2ME through the connection provided by the old SHO;

the M2ME is further configured to delete information of the old SHO in the M2ME.

The aforementioned system can also have the following feature:

the RO is configured to activate the TRE functional entity in the M2ME after receiving information of the new SHO and the parameters of the M2ME sent by an M2ME subscriber; and, the RO is further configured to send the new MCIM to the M2ME through the connection established by the TRE functional entity;

the M2ME is further configured to establish the connection with the RO through the TRE functional entity, and, delete information of the old SHO in the M2ME;

the new SHO is further configured to authorize the RO to provide the MCIM of the new SHO after verifying the M2ME by the PVA and the M2ME passes the verification.

The aforementioned system can also have the following feature:

the RO is further configured to notify the old SHO that the M2ME changes the SHO after receiving information of the new SHO and the parameters of the M2ME sent by an M2ME subscriber; and, the RO is further configured to send the new MCIM to the M2ME through the connection established by the TRE functional entity;

the old SHO is configured to activate the TRE functional entity in the M2ME through an over the air (OTA) mode;

the M2ME is further configured to establish the connection with the RO through the TRE functional entity, and, delete information of the old SHO in the M2ME;

the new SHO is further configured to authorize the RO to provide the MCIM of the new SHO after verifying the M2ME by the PVA and the M2ME passes the verification.

The aforementioned system can also have the following feature:

the old SHO is configured to activate the TRE functional entity in the M2ME through an over the air (OTA) mode after receiving information of the new SHO and the parameters of the M2ME sent by an M2ME subscriber;

the M2ME is further configured to establish the connection with the RO through the TRE functional entity, and, delete information of the old SHO in the M2ME;

the new SHO is further configured to authorize the RO to provide the MCIM of the new SHO after verifying the M2ME by the PVA and the M2ME passes the verification;

the RO is configured to send the new MCIM to the M2ME through the connection established by the TRE functional entity.

The present invention makes the M2M equipment combine with the TRE functional entity to provide the initial connection and the high security of the UICC, which realizes changing the selected home operator of the M2ME and ensures the security of the MCIM.

### BRIEF DESCRIPTION OF DRAWINGS

FIG. 1 is a schematic diagram of an M2ME architecture of a UICC (a TRE functional entity is in the M2ME) in accordance with an embodiment of the present invention;

FIG. 2 is an architecture diagram of an M2M system of a UICC (a TRE functional entity is in the M2ME) in accordance with an embodiment of the present invention;

FIG. 3 is a flow chart of changing a selected home operator of an M2M equipment by using a connection provided by an old SHO in accordance with an embodiment of the present invention;

FIG. 4 is a flow chart of changing a selected home operator of an M2M equipment through an RO in accordance with an embodiment of the present invention (embodiment 1);

FIG. 5 is a flow chart of changing a selected home operator of an M2M equipment through an RO in accordance with an embodiment of the present invention (embodiment 2);

FIG. 6 is a flow chart of changing a selected home operator of an M2M equipment through an RO by using an over the air (OTA) mode in accordance with an embodiment of the present invention (embodiment 1);

FIG. 7 is a flow chart of changing a selected home operator of an M2M equipment through an RO by using an OTA mode in accordance with an embodiment of the present invention (embodiment 2);

FIG. 8 is a flow chart of changing a selected home operator of an M2M equipment through an old SHO by using an OTA mode in accordance with an embodiment of the present invention (embodiment 1); and

FIG. 9 is a flow chart of changing a selected home operator of an M2M equipment through an old SHO by using an OTA mode in accordance with an embodiment of the present invention (embodiment 2).

### PREFERRED EMBODIMENTS OF THE PRESENT INVENTION

In the present invention, the TRE functional entity and the UICC are combined to realize changing the selected home operator of the M2ME, which ensures the security of the MCIM. Among them, the SHO can be replaced by adopting two modes:

mode one: a new SHO receives parameters of an M2ME, and after verifying the M2ME by a platform validation authority center (PVA) and the M2ME passes the verification, provides an MCIM of the new SHO to the M2ME through a connection between the M2ME and an RO (Registration Operator) provided by an old SHO; and the M2ME installs the new MCIM in a Universal Integrated Circuit Card (UICC);

mode two: a new SHO receives parameters of an M2ME, and after verifying the M2ME by a PVA and the M2ME passes the verification, provides an MCIM of the new SHO to the M2ME through a connection between the M2ME and an RO established by a TRE functional entity; and the M2ME installs the new MCIM in a UICC;

wherein, the UICC is located in the M2ME and the TRE functional entity is located in the M2ME.

In the following, the present invention will be illustrated in detail in combination with the accompanying drawings and specific embodiments.

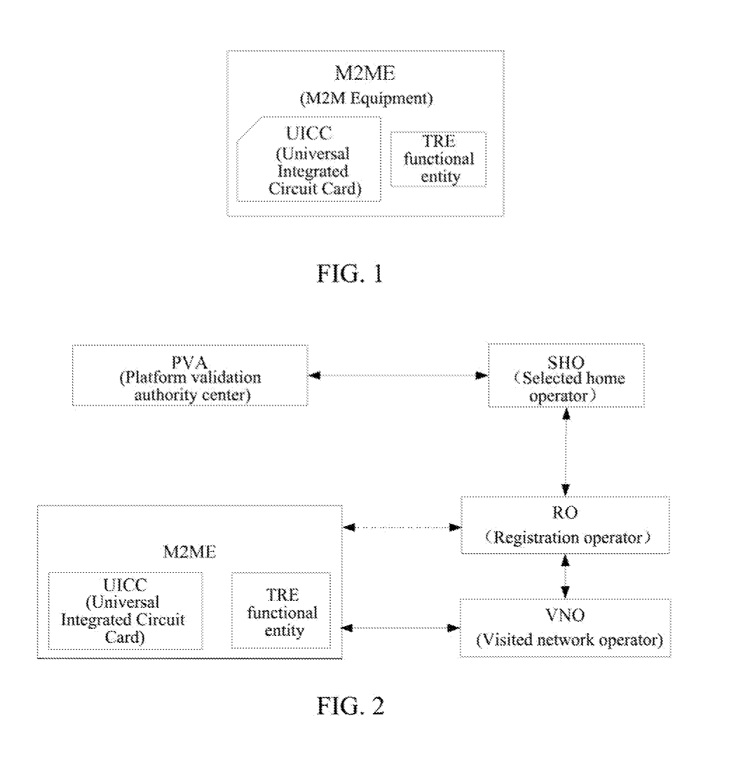

As shown in FIG. 1, it is a schematic diagram of an M2ME architecture based on a UICC (in which a TRE function entity is located in the M2ME) in accordance with an embodiment of the present invention. In that architecture, the TRE functional entity is located in the M2ME, and the UICC is installed in the M2ME.

As shown in FIG. 2, it is an architecture diagram of an M2M system based on a UICC (in which a TRE functional entity is located in the M2ME) in accordance with an embodiment of the present invention.

The M2ME takes a PICD (Provisional Connectivity Identity) as its private identification. To make the M2ME register to a 3GPP network unrelated to a home operator selected in the future, the PCID needs to be installed in the M2ME through the supplier. The PCID and the IMSI have the same format. Wherein, the TRE functional entity is a trusted environment provided by the M2ME, and it provides protection and isolation based on the hardware and software for providing, storing, executing and managing the MCIM; the security of the PCID is further ensured by the TRE functional entity, for example, the secure storage, retrieval and use of the PCID are implemented by the TRE functional entity. One TRE functional entity can be verified by an authorized external proxy at any time as desired. The UICC is installed in the M2ME.

The VNO (Visited Network Operator) provides the M2ME with an initial connection for an initial registration, as well as the provision of the MCIM and credential.

The RO can have the following functions:

1) DPF: MCIM Download and Provisioning Function;

2) DRF: Discovery and Registration Function;

3) ICF: Initial Connectivity Function.

The SHO provides an operation service for the M2ME, and authorizes the DPF to provide the M2ME with the MCIM generated by the SHO or by the DPF on behalf of the SHO.

The PVA is used to verify the M2ME.

In the present invention, when the MCIM is located in the UICC, the MCIM refers to USIM/ISIM. To describe conveniently, in the present invention, regardless of whether the MCIM is located in the UICC, only the MCIM can be used, but the USIM/ISIM is not used.

In the present invention, both the UICC and the TRE functional entity are located in the M2ME. The initial MCIM can be pre-installed in the UICC, or can be installed in the UICC through a remotely providing method. When the initial MCIM is installed in the UICC through the remotely providing method, the TRE functional entity is used to establish the initial connection between the M2ME and the visited network operator.

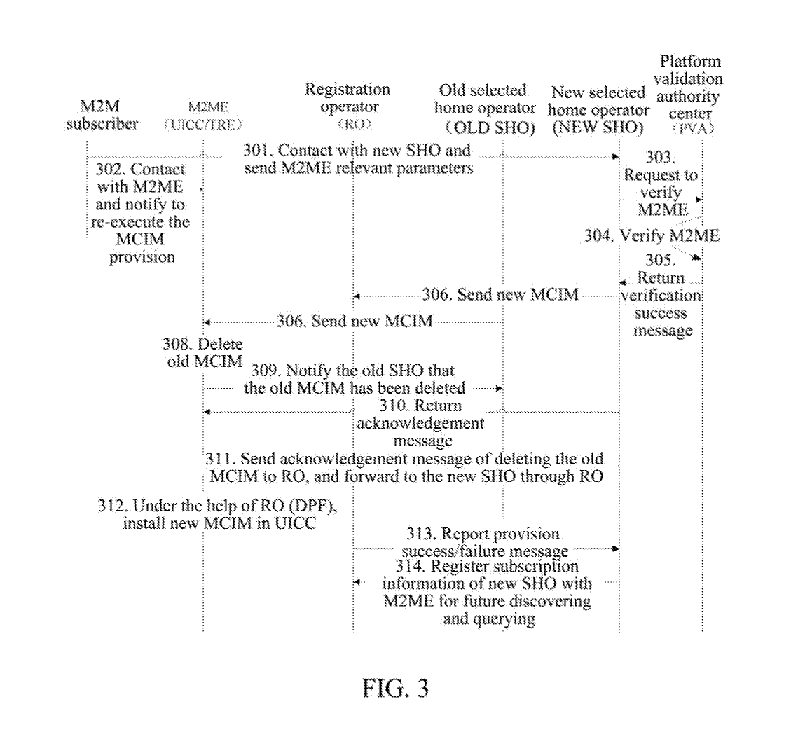

FIG. 3 is a flow chart of changing the selected home operator of the M2ME by using the connection provided by the old SHO of the mode one applied in an embodiment of the present invention.

As shown in FIG. 3, both the UICC and the TRE functional entity are located in the M2ME, and the UICC is installed with the MCIM of the old SHO. When an M2ME subscriber wants to change the SHO due to expiration of the contract between the M2ME subscriber and the old SHO or other reasons, the M2ME subscriber contacts with the new SHO, and at the same time contacts with the M2ME to notify the M2ME to execute the MCIM re-provisioning, so as to change the SHO of the M2ME. The specific flow of changing the selected home operator of the M2ME comprises the following steps.

In step 301, when the M2ME subscriber wants to change the SHO due to expiration of the contract between the M2ME subscriber and the old SHO or other reasons, the M2ME subscriber contacts with the new SHO and sends the M2ME relevant parameters.

In step 302, the M2ME subscriber contacts with the M2ME, and notifies the M2ME to execute the MCIM re-provisioning.

In step 303, the new SHO requests the PVA to verify the M2ME.

In step 304, the PVA verifies the M2ME.

In step 305, if the verification is passed, the PVA reports a verification success status information to the new SHO.

In step 306, the new SHO sends its MCIM to the RO (DPF function).

In step 307, the RO securely sends the new MCIM to the UICC in the M2ME by using the connection provided by the old SHO.

Specifically, the OTA mode can be used to download the new MCIM to the UICC of the M2ME. At the final stage of the OTA process, a new MCIM is activated. Meanwhile, the old SHO relevant information, including the MCIM of the old SHO, the credential and other information, is deleted.

In step 308, before the M2ME provides the downloaded new MCIM to the UICC, the M2ME deletes the information of the old SHO in the M2ME, and the information of the old SHO includes the MCIM of the old SHO, credential and other information.

In step 309, the M2ME sends a message to the old SHO to notify the old SHO that the information related to the old SHO is deleted already, and the information includes the MCIM of the old SHO, credential and other information.

In step 310, the old SHO returns an acknowledgement message to the M2ME to indicate that the above messages have been received. If necessary, the old SHO deletes the M2ME relevant information.

In step 311, the M2ME sends an acknowledgement message that the old MCIM has been deleted to the RO (DPF function), and forwards the acknowledgement message to the new SHO through the RO (DPF function), and the acknowledgement message has to be security filtered when the RO (DPF function) forwards the acknowledgement message, so as to prevent any sensitive information regarding to the old SHO from being acquired by the new SHO.

In step 312, under the help of the RO (DPF function), the M2ME installs the MCIM of the new SHO in the UICC.

A variety of modes in the related art can be used to address how the RO helps the M2ME to install the MCIM of the new SHO in the UICC, and herein the process is not elaborated.

In step 313, the RO (DPF function) reports a provisioning success/failure status information to the new SHO.

In step 314, the SHO sends a message to the RO (DRF function) to register the subscription information between the new SHO and the M2ME, so as to be used to discover and query in the future.

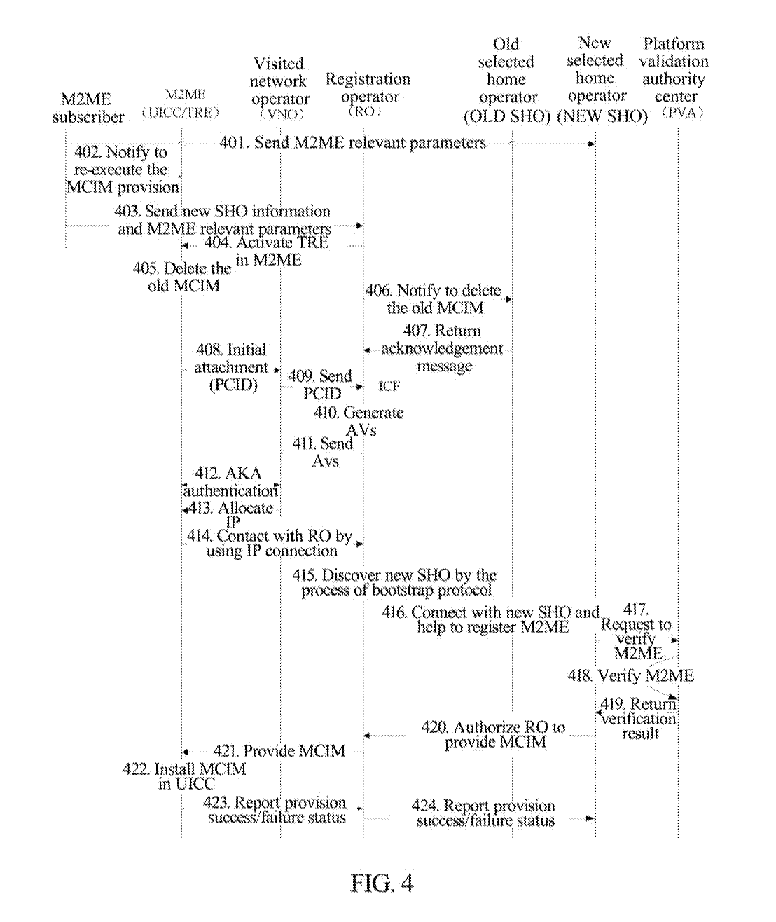

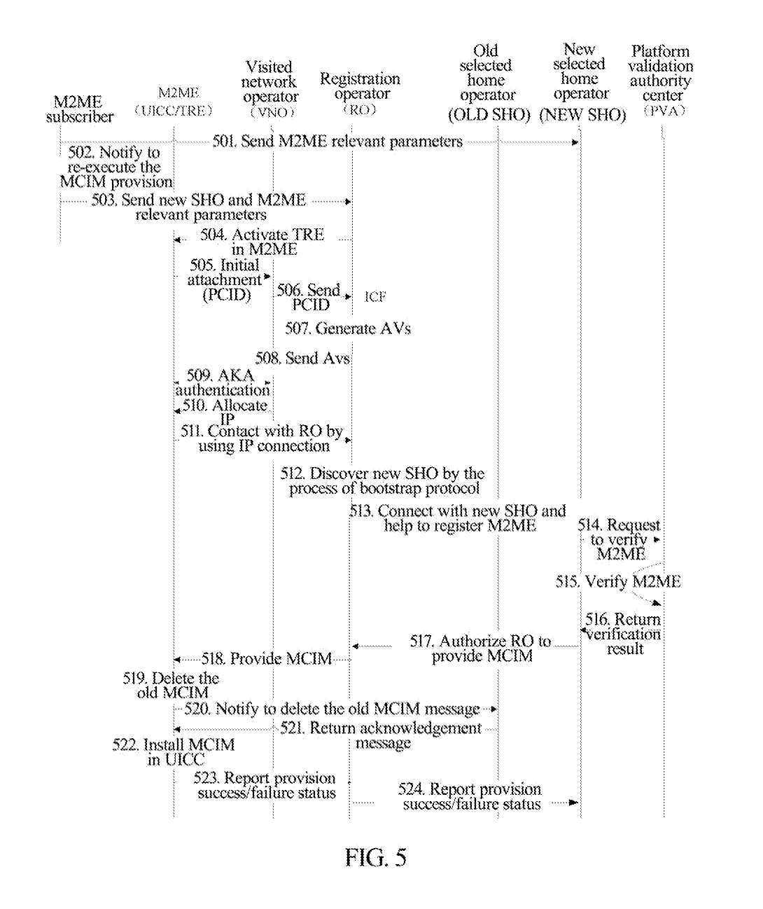

FIG. 4 is a flow chart of changing the selected home operator of the M2M equipment based on the UICC through the RO of the mode two applied in an embodiment of the present invention (embodiment 1).

As shown in FIG. 4, both the UICC and the TRE functional entity are located in the M2ME, and the UICC is installed with the MCIM of the old SHO. When the M2ME subscriber wants to change the SHO due to expiration of the contract between the M2ME subscriber and the old SHO or other reasons, the M2ME subscriber contacts with the new SHO and the RO, and meanwhile, contacts with the M2ME to notify the M2ME to execute the MCIM re-provisioning, so as to change the SHO of the M2ME. The specific flow of changing the selected home operator of the M2ME comprises the following steps.

In step 401, when the M2ME subscriber wants to change the SHO due to expiration of the contract between the M2ME subscriber and the old SHO, the M2ME subscriber contacts with the new SHO, and sends the M2ME relevant parameters.

In step 402, the M2ME subscriber contacts with the M2ME, and notifies the M2ME to execute the MCIM re-provisioning.

In step 403, the M2ME subscriber contacts with the RO, and sends the SHO information newly subscribed by the M2ME and the M2ME relevant parameters.

In step 404, the RO contacts with the M2ME through the connection provided by the old SHO, to activate the TRE functional entity in the M2ME.

In step 405, the RO helps the M2ME to delete information of the old SHO in the UICC; such as deleting the credential of the old SHO, and meanwhile, deleting the MCIM of the old SHO.

The M2ME also can manually delete the information of the old SHO in the UICC after the TRE is activated; such as deleting the credential of the old SHO, and deleting the MCIM of the old SHO at the same time.

A variety of modes in the related art can be used to address how the RO helps the M2ME to delete the information of the old SHO in the UICC, and herein the process is not elaborated.

In step 406, the RO sends a message to the old SHO to notify the old SHO that the M2ME has deleted the MCIM of the old SHO in the UICC.

In step 407, the old SHO returns an acknowledgement message to the RO to indicate that the old SHO receives the aforementioned information.

In step 408, the M2ME establishes an initial connection with the randomly selected VNO through the TRE functional entity. The M2ME, by a standard GSM/UMTS principle, decodes the network information and attaches to any VNO. In an attachment message, the M2ME sends a Provisional Connectivity ID (PCID) to the VNO.

In step 409, The VNO contacts with the RO (ICF function), and sends the PCID to the RO (ICF function). Note that, in some cases, the RO can be located in the VNO.

In step 410, after the RO (ICF function) receives the PCID, it generates a set of authentication vectors (AVs) regarding to the PCID.

In step 411, the RO sends the generated authentication vectors (AVs) to the VNO.

In step 412, the VNO authenticates the PCID/M2ME by using the AVs, it can use, but not limited to, an Authentication and Key Agreement (AKA) to authenticate.

In step 413, after the authentication is successful, the VNO provides the M2ME with an IP connection to the RO. The VNO allocates an IP address to the M2ME.

In step 414, the M2ME contacts with the RO through the IP connection provided by the VNO network.

In step 415, with the help of the RO, the M2ME discovers a new SHO, or, the RO itself discovers a new SHO for the M2ME. The new SHO discovery process can use an OMA (Open Mobile Alliance) BOOTSTRAP (i.e., the Bootstrap Protocol).

In step 416, the RO connects with the new SHO and registers the M2ME to be connected with a new SHO network in the new SHO.

In step 417, the new SHO requests the PVA (or requests the PVA through the RO) to verify the authenticity and integrity of the M2ME.

In step 418, the PVA verifies the authenticity and integrity of the M2ME.

In step 419, the PVA sends the verification result to the new SHO.

In step 420, if the verification is successful, the new SHO contacts with the RO (DPF function), and authorizes the RO (DPF function) to provide the MCIM to the M2ME.

In step 421, the RO (DPF function) sends the MCIM of the new SHO to the M2ME.

In step 422, the M2ME installs the MCIM of the new SHO in the UICC.

In step 423, the M2ME reports a MCIM provisioning success/failure status information to the RO (DPF function).

In step 424, the RO (DPF function) reports the MCIM provisioning success/failure status information to the new SHO.

FIG. 5 is a flow chart of changing the selected home operator of the M2M equipment based on the UICC through the RO of the mode two applied in an embodiment of the present invention (embodiment 2).

As shown in FIG. 5, both the UICC and the TRE functional entity are located in the M2ME, and the UICC is installed with the MCIM of the old SHO. When the M2ME subscriber wants to change the SHO due to expiration of the contract between the M2ME subscriber and the old SHO or other reasons, the M2ME subscriber contacts with the new SHO and the RO, and meanwhile, contacts with the M2ME to notify the M2ME to execute the MCIM re-provisioning, so as to change the SHO of the M2ME. The specific flow of changing the selected home operator of the M2ME comprises the following steps.

In step 501, when the M2ME subscriber wants to change the SHO due to expiration of the contract between the M2ME subscriber and the old SHO, the M2ME subscriber contacts with the new SHO, and sends the M2ME relevant parameters.

In step 502, the M2ME subscriber contacts with the M2ME, and notifies the M2ME to execute the MCIM re-provisioning.

In step 503, the M2ME subscriber contacts with the RO, and sends the information of the SHO newly subscribed by the M2ME and the M2ME relevant parameters.

In step 504, the RO contacts with the M2ME through the connection provided by the old SHO, to activate the TRE functional entity in the M2ME.

After the TRE functional entity is activated, the old MCIM stops working.

In step 505, the M2ME establishes the initial connection with the randomly selected VNO through the TRE functional entity. The M2ME, by a standard GSM/UMTS principle, decodes the network information and attaches to any VNO. In an attachment message, the M2ME sends a PCID to the VNO.

In step 506, The VNO contacts with the RO (ICF function), and sends the PCID to the RO (ICF function). Note that, in some cases, the RO can be located in the VNO.

In step 507, after the RO (ICF function) receives the PCID, it generates a set of authentication vectors (AVs) regarding to the PCID.

In step 508, the RO sends the generated authentication vectors (AVs) to the VNO.

In step 509, the VNO uses the AVs to authenticate the PCID/M2ME, it can use, but not limited to, an AKA to authenticate.

In step 510, after the authentication is successful, the VNO provides the M2ME with an IP connection to the RO. The VNO allocates an IP address to the M2ME.

In step 511, the M2ME contacts with the RO through the IP connection provided by the VNO network.

In step 512, with the help of the RO, the M2ME discovers a new SHO, or, the RO itself discovers a new SHO for the M2ME. The new SHO discovery process can use an OMA BOOTSTRAP.

In step 513, the RO connects with the new SHO and registers the M2ME to be connected with a new SHO network in the new SHO.

In step 514, the new SHO requests the PVA (or requests the PVA through the RO) to verify the authenticity and integrity of the M2ME.

In step 515, the PVA verifies the authenticity and integrity of the M2ME.

In step 516, the PVA sends the verification result to the new SHO.

In step 517, if the verification is successful, the new SHO contacts with the RO (DPF function), and authorizes the RO (DPF function) to provide the MCIM to the M2ME.

In step 518, the RO (DPF function) sends the MCIM of the new SHO to the M2ME.

In step 519, before installing the MCIM obtained from the new SHO, the M2ME deletes information of the old SHO in the UICC, such as the credential of the old SHO, and meanwhile, deletes the MCIM of the old SHO.

In step 520, after deleting the old MCIM in the UICC, the M2ME sends the message that the old MCIM has been deleted to the old SHO through the RO.

In step 521, the old SHO returns an acknowledgement message to the M2ME through the RO to indicate that the old SHO receives the aforementioned information. If necessary, the RO forwards the acknowledgement message to the new SHO. The acknowledgement message has to be privately filtered before the RO forwards the acknowledgement message, so as to prevent the sensitive information related to the old SHO from being acquired by the new SHO.

In step 522, the M2ME, directly or under the help of the RO (DPF), installs the MCIM in the UICC.

In step 523, after the M2ME directly installs the MCIM in the UICC, the M2ME reports an MCIM provisioning success/failure status information to the RO (DPF function). If the M2ME installs the MCIM in the UICC under the help of the RO (DPF), then the RO (DPF) already knows whether the MCIM has been successfully installed in the UICC.

In step 524, the RO (DPF function) reports the MCIM provisioning success/failure status information to the new SHO.

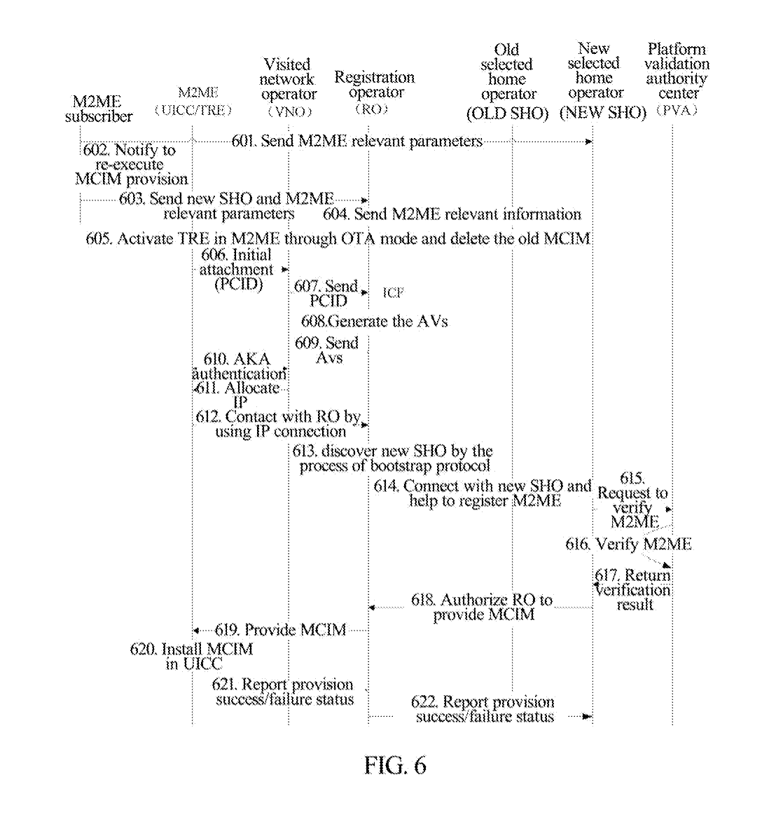

FIG. 6 is a flow chart of changing the selected home operator of the M2M equipment through the RO by using the OTA (Over The Air) with the mode two in accordance with an embodiment of the present invention (embodiment 1).

As shown in FIG. 6, both the UICC and the TRE functional entity are located in the M2ME, and the UICC is installed with the MCIM of the old SHO. When the M2ME subscriber wants to change the SHO due to expiration of the contract between the M2ME subscriber and the old SHO or other reasons, the M2ME subscriber contacts with the new SHO and the RO, and meanwhile, contacts with the M2ME to notify the M2ME to execute the MCIM re-provisioning, so as to change the SHO of the M2ME. The specific flow of changing the selected home operator of the M2ME comprises the following steps.

In step 601, when the M2ME subscriber wants to change the SHO due to expiration of the contract between the M2ME subscriber and the old SHO, the M2ME subscriber contacts with the new SHO, and sends the M2ME relevant parameters.

In step 602, the M2ME subscriber contacts with the M2ME, and notifies the M2ME to execute the MCIM re-provisioning.

In step 603, the M2ME subscriber contacts with the RO, and sends the information of the SHO newly subscribed by the M2ME and the M2ME relevant parameters.

In step 604, the RO contacts with the old SHO, and notifies the old SHO of the relevant information of the M2ME who will change the selected home operator.

In step 605, the old SHO activates the TRE functional entity in the M2ME through the OTA mode, and deletes information of the old SHO in the UICC of the M2ME, such as the credential of the old SHO, and meanwhile, deletes the MCIM of the old SHO.

In step 606, the M2ME establishes the initial connection with the randomly selected VNO through the TRE functional entity. The M2ME, by a standard GSM/UMTS principle, decodes the network information and attaches to any VNO. In an attachment message, the M2ME sends a PCID to the VNO.

In step 607, the VNO contacts with the RO (ICF function), and sends the PCID to the RO (ICF function). Note that, in some cases, the RO can be located in the VNO.

In step 608, after the RO (ICF function) receives the PCID, it generates a set of authentication vectors (AVs) regarding to the PCID.

In step 609, the RO sends the generated authentication vectors (AVs) to the VNO.

In step 610, the VNO uses the AVs to authenticate the PCID/M2ME, it can use, but not limited to, the AKA to authenticate.

In step 611, after the authentication is successful, the VNO provides the M2ME with the IP connection to the RO. The VNO allocates an IP address to the M2ME.

In step 612, the M2ME contacts with the RO through the IP connection provided by the VNO network.

In step 613, with the help of the RO, the M2ME discovers a new SHO, or, the RO itself discovers a new SHO for the M2ME. The new SHO discovery process can use the OMA BOOTSTRAP.

In step 614, the RO connects with the new SHO and registers the M2ME to be connected with the new SHO network in the new SHO.

In step 615, the new SHO requests the PVA (or requests the PVA through the RO) to verify the authenticity and integrity of the M2ME.

In step 616, the PVA verifies the authenticity and integrity of the M2ME.

In step 617, the PVA sends the verification result to the new SHO.

In step 618, if the verification is successful, the new SHO contacts with the RO (DPF function), and authorizes the RO (DPF function) to provide the MCIM to the M2ME.

In step 619, the RO (DPF function) sends the MCIM of the new SHO to the M2ME.

In step 620, the M2ME installs the MCIM of the new SHO in the UICC.

In step 621, the M2ME reports an MCIM provisioning success/failure status information to the RO (DPF function).

In step 622, the RO (DPF function) reports the MCIM provisioning success/failure status information to the new SHO.

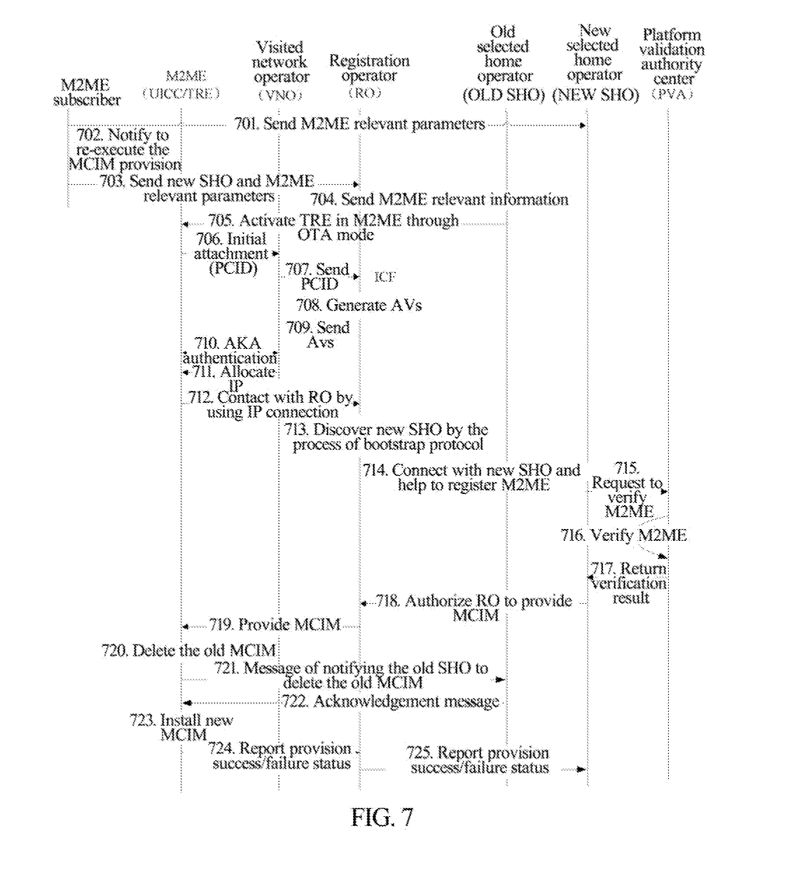

FIG. 7 is a flow chart of changing the selected home operator of the M2M equipment by using the OTA mode and through the RO with the mode two in accordance with an embodiment of the present invention (embodiment 2).

As shown in FIG. 7, both the UICC and the TRE functional entity are located in the M2ME, and the UICC is installed with the MCIM of the old SHO. When the M2ME subscriber wants to change the SHO due to expiration of the contract between the M2ME subscriber and the old SHO or other reasons, the M2ME subscriber contacts with the new SHO and the RO, and meanwhile, contacts with the M2ME to notify the M2ME to execute the MCIM re-provisioning, so as to change the SHO of the M2ME. The specific flow of changing the selected home operator of the M2ME comprises the following steps.

In step 701, when the M2ME subscriber wants to change the SHO due to expiration of the contract between the M2ME subscriber and the old SHO, the M2ME subscriber contacts with the new SHO, and sends the M2ME relevant parameters.

In step 702, the M2ME subscriber contacts with the M2ME, and notifies the M2ME to execute the MCIM re-provisioning.

In step 703, the M2ME subscriber contacts with the RO, and sends the information of the SHO newly subscribed by the M2ME and the M2ME relevant parameters.

In step 704, the RO contacts with the old SHO, and notifies the old SHO of the relevant information of the M2ME who will change the selected home operator.

In step 705, the old SHO activates the TRE functional entity in the M2ME through the OTA mode.

After the TRE functional entity is activated, the old MCIM stops working.

In step 706, the M2ME establishes the initial connection with the randomly selected VNO through the TRE functional entity. The M2ME, by a standard GSM/UMTS principle, decodes the network information and attaches to any VNO. In an attachment message, the M2ME sends a PCID to the VNO.

In step 707, the VNO contacts with the RO (ICF function), and sends the PCID to the RO (ICF function). Note that, in some cases, the RO can be located in the VNO.

In step 708, after the RO (ICF function) receives the PCID, it generates a set of authentication vectors (AVs) regarding to the PCID.

In step 709, the RO sends the generated authentication vectors (AVs) to the VNO.

In step 710, the VNO uses the AVs to authenticate the PCID/M2ME, it can use, but not limited to, the AKA to authenticate.

In step 711, after the authentication is successful, the VNO provides the M2ME with the IP connection to the RO. The VNO allocates an IP address to the M2ME.

In step 712, the M2ME contacts with the RO through the IP connection provided by the VNO network.

In step 713, with the help of the RO, the M2ME discovers a new SHO, or, the RO itself discovers a new SHO for the M2ME. The new SHO discovery process can use the OMA BOOTSTRAP.

In step 714, the RO connects with the new SHO and registers the M2ME to be connected with the new SHO network in the new SHO.

In step 715, the new SHO requests the PVA (or requests the PVA through the RO) to verify the authenticity and integrity of the M2ME.

In step 716, the PVA verifies the authenticity and integrity of the M2ME.

In step 717, the PVA sends the verification result to the new SHO.

In step 718, if the verification is successful, the new SHO contacts with the RO (DPF function), and authorizes the RO (DPF function) to provide the MCIM to the M2ME.

In step 719, the RO (DPF function) sends the MCIM of the new SHO to the M2ME.

In step 720, before installing the MCIM obtained from the new SHO, the M2ME deletes information of the old SHO in the UICC, such as the credential of the old SHO, and meanwhile, deletes the MCIM of the old SHO.

In step 721, after deleting the old MCIM in the UICC, the M2ME sends a message that the old MCIM has been deleted to the old SHO through the RO.

In step 722, the old SHO returns an acknowledgement message to the M2ME through the RO to indicate that the old SHO receives the aforementioned information. If necessary, the RO forwards the acknowledgement message to the new SHO. The acknowledgement message has to be privately filtered before the RO forwards the acknowledgement message, so as to prevent sensitive information related to the old SHO from being acquired by the new SHO.

In step 723, the M2ME, directly or under the help of the RO (DPF), installs the MCIM in the UICC.

In step 724, after the M2ME directly installs the MCIM in the UICC, the M2ME reports an MCIM provisioning success/failure status information to the RO (DPF function). If the M2ME installs the MCIM in the UICC under the help of the RO (DPF), then the RO (DPF) already knows whether the MCIM has been successfully installed in the UICC.

In step 725, the RO (DPF function) reports the MCIM provisioning success/failure status information to the new SHO.

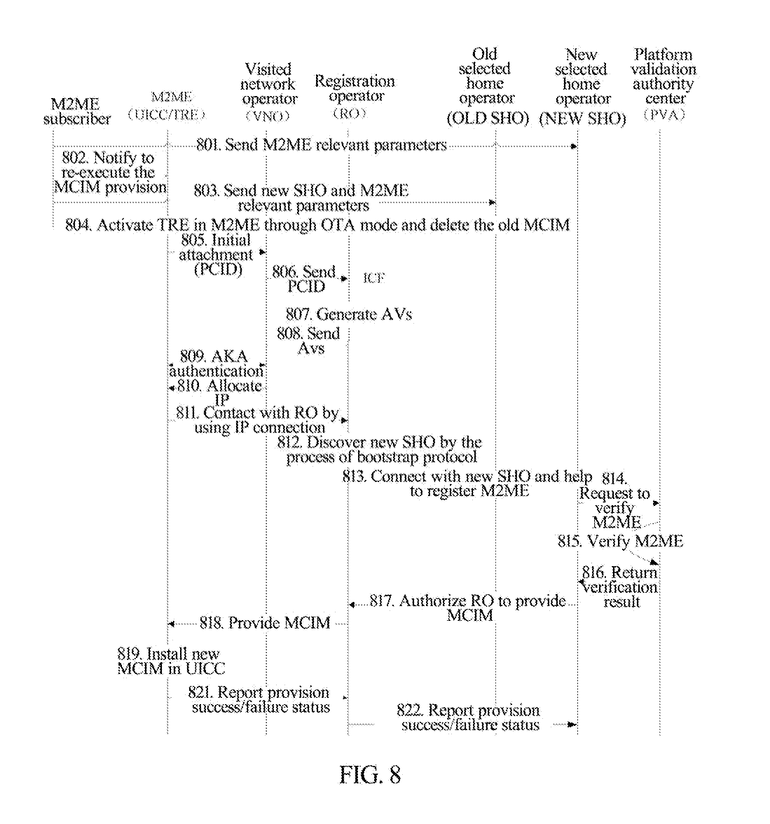

FIG. 8 is a flow chart of changing the selected home operator of the M2M equipment by using the OTA mode and through the old SHO with the mode two in accordance with an embodiment of the present invention (embodiment 1).

As shown in FIG. 8, both the UICC and the TRE functional entity are located in the M2ME, and the UICC is installed with the MCIM of the old SHO. When the M2ME subscriber wants to change the SHO due to expiration of the contract between the M2ME subscriber and the old SHO or other reasons, the M2ME subscriber contacts with the new SHO and the RO, and meanwhile, contacts with the M2ME to notify the M2ME to execute the MCIM re-provisioning, so as to change the SHO of the M2ME. The specific flow of changing the selected home operator of the M2ME comprises the following steps.

In step 801, when the M2ME subscriber wants to change the SHO due to expiration of the contract between the M2ME subscriber and the old SHO, the M2ME subscriber contacts with the new SHO, and sends the M2ME relevant parameters.

In step 802, the M2ME subscriber contacts with the M2ME, and notifies the M2ME to execute the MCIM re-provisioning.

In step 803, the M2ME subscriber contacts with the old SHO, and sends the information of the SHO newly subscribed by the M2ME and the M2ME relevant parameters.

In step 804, the old SHO activates the TRE functional entity in the M2ME through the OTA mode, and deletes information of the old SHO in the UICC of the M2ME, such as the credential of the old SHO, and meanwhile, deletes the MCIM of the old SHO.

In step 805, the M2ME establishes the initial connection with the randomly selected VNO through the TRE functional entity. The M2ME, by a standard GSM/UMTS principle, decodes the network information and attaches to any VNO. In an attachment message, the M2ME sends a PCID to the VNO.

In step 806, the VNO contacts with the RO (ICF function), and sends the PCID to the RO (ICF function). Note that, in some cases, the RO can be located in the VNO.

In step 807, after the RO (ICF function) receives the PCID, it generates a set of authentication vectors (AVs) regarding to the PCID.

In step 808, the RO sends the generated authentication vectors (AVs) to the VNO.

In step 809, the VNO uses the AVs to authenticate the PCID/M2ME, it can use, but not limited to, the AKA to authenticate.

In step 810, after the authentication is successful, the VNO provides the M2ME with the IP connection to the RO. The VNO allocates an IP address to the M2ME.

In step 811, the M2ME contacts with the RO through the IP connection provided by the VNO network.

In step 812, with the help of the RO, the M2ME discovers a new SHO, or, the RO itself discovers a new SHO for the M2ME. The new SHO discovery process can use the OMA BOOTSTRAP.

In step 813, the RO connects with the new SHO and registers the M2ME to be connected with the new SHO network in the new SHO.

In step 814, the new SHO requests the PVA (or requests the PVA through the RO) to verify the authenticity and integrity of the M2ME.

In step 815, the PVA verifies the authenticity and integrity of the M2ME.

In step 816, the PVA sends the verification result to the new SHO.

In step 817, if the verification is successful, the new SHO contacts with the RO (DPF function), and authorizes the RO (DPF function) to provide the new MCIM to the M2ME.

In step 818, the RO (DPF function) sends the MCIM of the new SHO to the M2ME.

In step 819, the M2ME installs the MCIM of the new SHO in the UICC.

In step 820, the M2ME reports an MCIM provisioning success/failure status information to the RO (DPF function).

In step 821, the RO (DPF function) reports the MCIM provisioning success/failure status information to the new SHO.

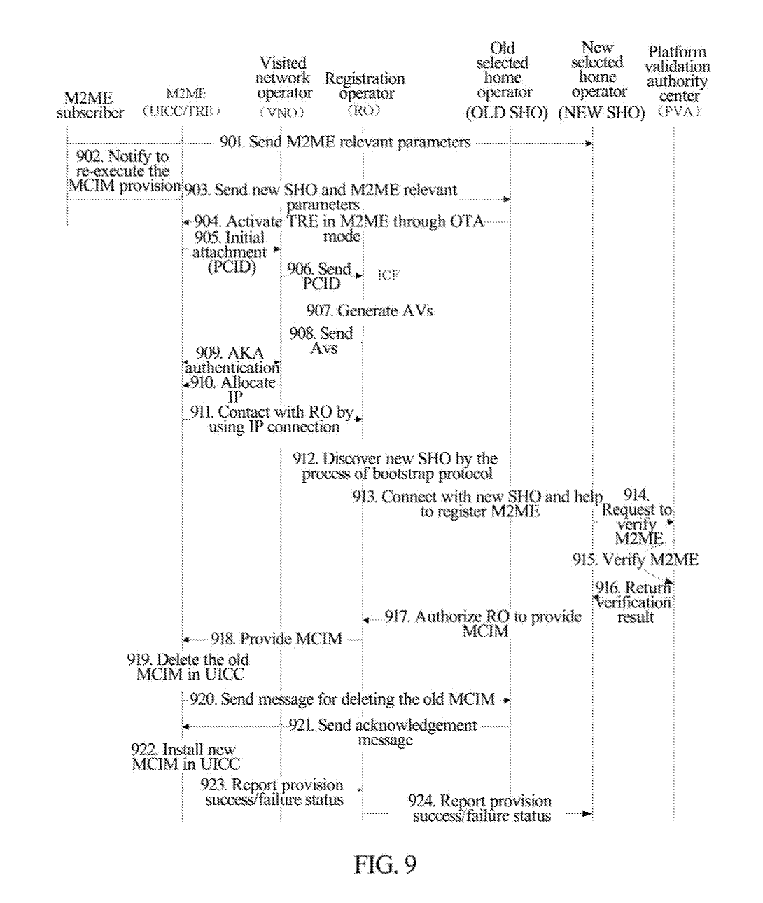

FIG. 9 is a flow chart of changing the selected home operator of the M2M equipment by using the OTA mode and through the old SHO with the mode two in accordance with an embodiment of the present invention (embodiment 2).

As shown in FIG. 9, both the UICC and the TRE functional entity are located in the M2ME, and the UICC is installed with the MCIM of the old SHO. When the M2ME subscriber wants to change the SHO due to expiration of the contract between the M2ME subscriber and the old SHO or other reasons, the M2ME subscriber contacts with the new SHO and the RO, and meanwhile, contacts with the M2ME to notify the M2ME to execute the MCIM re-provisioning, so as to change the SHO of the M2ME. The specific flow of changing the selected home operator of the M2ME comprises the following steps.

In step 901, when the M2ME subscriber wants to change the SHO due to expiration of the contract between the M2ME subscriber and the old SHO, the M2ME subscriber contacts with the new SHO, and sends the M2ME relevant parameters.

In step 902, the M2ME subscriber contacts with the M2ME, and notifies the M2ME to execute the MCIM re-provisioning.

In step 903, the M2ME subscriber contacts with the old SHO, and sends the information of the SHO newly subscribed by the M2ME and the M2ME relevant parameters.

In step 904, the old SHO activates the TRE functional entity in the M2ME through the OTA mode.

After the TRE functional entity is activated, the old MCIM stops working.

In step 905, the M2ME establishes the initial connection with the randomly selected VNO through the TRE functional entity. The M2ME, by a standard GSM/UMTS principle, decodes the network information and attaches to any VNO. In an attachment message, the M2ME sends a PCID to the VNO.

In step 906, the VNO contacts with the RO (ICF function), and sends the PCID to the RO (ICF function). Note that, in some cases, the RO can be located in the VNO.

In step 907, after the RO (ICF function) receives the PCID, it generates a set of authentication vectors (AVs) regarding to the PCID.

In step 908, the RO sends the generated authentication vectors (AVs) to the VNO.

In step 909, the VNO uses the AVs to authenticate the PCID/M2ME, it can use, but not limited to, the AKA to authenticate.

In step 910, after the authentication is successful, the VNO provides the M2ME with the IP connection to the RO. The VNO allocates an IP address to the M2ME.

In step 911, the M2ME contacts with the RO through the IP connection provided by the VNO network.

In step 912, with the help of the RO, the M2ME discovers a new SHO, or, the RO itself discovers a new SHO for the M2ME. The new SHO discovery process can use the OMA BOOTSTRAP.

In step 913, the RO connects with the new SHO and registers the M2ME to be connected with the new SHO network in the new SHO.

In step 914, the new SHO requests the PVA (or requests the PVA through the RO) to verify the authenticity and integrity of the M2ME.

In step 915, the PVA verifies the authenticity and integrity of the M2ME.

In step 916, the PVA sends the verification result to the new SHO.

In step 917, if the verification is successful, the new SHO contacts with the RO (DPF function), and authorizes the RO (DPF function) to provide the MCIM to the M2ME.

In step 918, the RO (DPF function) sends the MCIM of the new SHO to the M2ME.

In step 919, before installing the MCIM obtained from the new SHO, the M2ME deletes information of the old SHO in the UICC, such as the credential of the old SHO, and meanwhile, deletes the MCIM of the old SHO.

In step 920, after deleting the old MCIM in the UICC, the M2ME sends a message that the old MCIM has been deleted to the old SHO through the RO.

In step 921, the old SHO returns an acknowledgement message to the M2ME through the RO to indicate that the old SHO receives the aforementioned information. If necessary, the RO forwards the acknowledgement message to the new SHO. The acknowledgement message has to be privately filtered before the RO forwards the acknowledgement message, so as to prevent sensitive information related to the old SHO from being acquired by the new SHO.

In step 922, the M2ME, directly or under the help of the RO (DPF), installs the MCIM in the UICC.

In step 923, after the M2ME directly installs the MCIM in the UICC, the M2ME reports an MCIM provisioning success/failure status information to the RO (DPF function). If the M2ME installs the MCIM in the UICC under the help of the RO (DPF), then the RO (DPF) already knows whether the MCIM has been successfully installed in the UICC.

In step 924, the RO (DPF function) reports the MCIM provisioning success/failure status information to the new SHO.

A system for changing the selected home operator of the M2M equipment in accordance with an embodiment of the present invention, comprising: an M2ME, a new SHO, an old SHO, a PVA and an RO.

The new SHO is configured to, receive parameters of the M2ME, and after verifying the M2ME by the PVA and the M2ME passes the verification, provide an MCIM of the new SHO to the M2ME through a connection between the M2ME and the RO provided by the old SHO or through a connection between the M2ME and the RO established by a TRE functional entity;

the M2ME is configured to install the new MCIM in a UICC;

wherein, both the UICC and the TRE functional entity are located in the M2ME.

The new SHO is further configured to send the MCIM of the new SHO to the RO after verifying the M2ME by the PVA and the M2ME passes the verification; the RO is configured to send the new MCIM to the M2ME through the connection provided by the old SHO; the M2ME is further configured to delete information of the old SHO in the M2ME, such as the old MCIM.

The RO is configured to activate the TRE functional entity in the M2ME after receiving information of the new SHO and the parameters of the M2ME sent by an M2ME subscriber; and, the RO sends the new MCIM to the M2ME through the connection established by the TRE functional entity; the M2ME is further configured to establish the connection with the RO through the TRE functional entity, and, is configured to delete information of the old SHO in the M2ME, such as the old MCIM; the new SHO is further configured to authorize the RO to provide the MCIM of the new SHO after verifying the M2ME by the PVA and the M2ME passes the verification.

The RO is configured to notify the old SHO that the M2ME changes the SHO after receiving information of the new SHO and the parameters of the M2ME sent by an M2ME subscriber; and, the RO sends the new MCIM to the M2ME through the connection established by the TRE functional entity; the old SHO is configured to activate the TRE functional entity in the M2ME through an OTA mode; the M2ME is further configured to establish the connection with the RO through the TRE functional entity, and, is configured to delete information of the old SHO in the M2ME; the new SHO is further configured to authorize the RO to provide the MCIM of the new SHO after verifying the M2ME by the PVA and the M2ME passes the verification.

The old SHO is configured to activate the TRE functional entity in the M2ME through an OTA mode after receiving information of the new SHO and the parameters of the M2ME sent by an M2ME subscriber; the M2ME is further configured to establish the connection with the RO through the TRE functional entity, and, is configured to delete information of the old SHO in the M2ME; the new SHO is further configured to authorize the RO to provide the MCIM of the new SHO after verifying the M2ME by the PVA and the M2ME passes the verification; the RO is configured to send the new MCIM to the M2ME through the connection established by the TRE functional entity.

Although the present invention is described in combination with the specific embodiments, for those skilled in the art, the present invention can be modified and changed without departing from the spirit or scope of the present invention. Such modifications and changes are considered within the scope of the present invention and the scope of the appending claims.

### INDUSTRIAL APPLICABILITY

The present invention provides a method and system for changing the selected home operator of the M2ME, which, by making the M2ME combine with the TRE functional entity to provide the initial connection and the high security of the UICC, realizes changing the selected home operator of the M2ME and ensures the security of the MCIM.

What is claimed is:

1. A method for changing a selected home operator of a machine to machine (M2M) equipment, comprising:
mode one: a new selected home operator (SHO) receiving parameters of a machine to machine equipment (M2ME), and after verifying the M2ME by a platform validation authority center (PVA) and the M2ME passes the verification, providing a machine communication identity module (MCIM) of the new SHO to the M2ME by a connection between the M2ME and a registration operator (RO) provided by an old SHO; and the M2ME installing the new MCIM in a universal integrated circuit card (UICC); or,
mode two: a new SHO receiving parameters of an M2ME, and after verifying the M2ME by a PVA and the M2ME passes the verification, providing an MCIM of the new SHO to the M2ME through a connection between the M2ME and a RO established by a trusted environment (TRE) functional entity; and the M2ME installing the new MCIM in a UICC;
wherein, both the UICC and the TRE functional entity are located in the M2ME.

2. The method according to claim 1, wherein, in the mode one, the step of the new SHO receiving the parameters of the M2ME and providing the MCIM to the M2ME comprises:
an M2ME subscriber sending the parameters of the M2ME to the new SHO and notifying the M2ME to execute an MCIM re-provisioning;
the new SHO, after verifying the M2ME by the PVA and the M2ME passes the verification, sending the MCIM of the new SHO to the RO;
the RO sending the new MCIM to the M2ME through the connection provided by the old SHO.

3. The method according to claim 2, wherein,
after performing the step of the RO sending the new MCIM to the M2ME, and before performing the step of the M2ME installing the new MCIM in the UICC, a step further performed is:
the M2ME deleting information of the old SHO in the M2ME, wherein the information of the old SHO comprises the MCIM of the old SHO.

4. The method according to claim 1, wherein, in the mode two, the step of the new SHO receiving the parameters of the M2ME and providing the MCIM to the M2ME comprises:
an M2ME subscriber sending the parameters of the M2ME to the new SHO, and notifying the M2ME to execute an MCIM re-provisioning, and, sending information of the new SHO and the parameters of the M2ME to the RO;
the RO activating the TRE functional entity in the M2ME;
the M2ME establishing the connection with the RO through the TRE functional entity, and the RO registering the M2ME in the new SHO;
the new SHO, after verifying the M2ME by the PVA and the M2ME passes the verification, authorizing the RO to provide the MCIM of the new SHO;
the RO sending the new MCIM to the M2ME through the connection established by the TRE functional entity.

5. The method according to claim 4, wherein,
after performing the step of the RO activating the TRE functional entity in the M2ME and before performing the step of the M2ME establishing the connection with the RO through the TRE functional entity, a step further performed is: the M2ME deleting information of the old SHO in the M2ME; or,
after performing the step of the RO sending the new MCIM to the M2ME and before performing the step of the M2ME installing the new MCIM in the UICC, a step further performed is: the M2ME deleting information of the old SHO in the M2ME;
wherein, the information of the old SHO comprises the MCIM of the old SHO.

6. The method according to claim 1, wherein, in the mode two, the step of the new SHO receiving the parameters of the M2ME and providing the MCIM to the M2ME comprises:
an M2ME subscriber sending the parameters of the M2ME to the new SHO, and notifying the M2ME to execute an MCIM re-provisioning, and, sending information of the new SHO and the parameters of the M2ME to the RO;
the RO notifying the old SHO that the M2ME changes the SHO;
the old SHO activating the TRE functional entity in the M2ME through an over the air (OTA) mode;
the M2ME establishing the connection with the RO through the TRE functional entity, and the RO registering the M2ME in the new SHO;
the new SHO, after verifying the M2ME by the PVA and the M2ME passes the verification, authorizing the RO to provide the MCIM of the new SHO;
the RO sending the new MCIM to the M2ME through the connection established by the TRE functional entity.

7. The method according to claim 1, wherein, in the mode two, the step of the new SHO receiving the parameters of the M2ME and providing the MCIM to the M2ME comprises:
an M2ME subscriber sending the parameters of the M2ME to the new SHO, and notifying the M2ME to execute an MCIM re-provisioning, and, sending information of the new SHO and the parameters of the M2ME to the old SHO;
the old SHO activating the TRE functional entity in the M2ME through an over the air (OTA) mode;
the M2ME establishing the connection with the RO through the TRE functional entity, and the RO registering the M2ME in the new SHO;
the new SHO, after verifying the M2ME by the PVA and the M2ME passes the verification, authorizing the RO to provide the MCIM of the new SHO;
the RO sending the new MCIM to the M2ME through the connection established by the TRE functional entity.

8. The method according to claim 6, wherein,
in the step of the old SHO activating the TRE functional entity in the M2ME, the old SHO further deletes information of the old SHO in the M2ME at the same time; or,
after performing the step of the RO sending the new MCIM to the M2ME and before performing the step of the M2ME installing the new MCIM in the UICC, a step further performed is: the M2ME deleting information of the old SHO in the M2ME;
wherein, the information of the old SHO comprises the MCIM of the old SHO.

9. The method according to claim 4, wherein,
the step of the M2ME establishing the connection with the RO through the TRE functional entity and the RO registering the M2ME in the new SHO comprises:
the M2ME establishing an initial connection with a randomly selected visited network operator (VNO) through the TRE functional entity;
the VNO contacting with the RO, and sending a provisional connectivity identity (PCID) received from the M2ME to the RO;
the RO generating a set of authentication vectors regarding to the PCID, and sending to the VNO;
the VNO authenticating the PCID and the M2ME by using the authentication vectors, and after the authentication is passed, the VNO providing the M2ME with an IP connection to the RO;
the M2ME contacting with the RO through the IP connection provided by the VNO;
the RO discovering the new SHO for the M2ME, or, the M2ME discovering the new SHO through the RO;
the RO connecting with the new SHO, and registering the M2ME in the new SHO.

10. A system for changing a selected home operator of a machine to machine (M2M) equipment, comprising: a machine to machine equipment (M2ME), a new selected home operator (SHO), an old SHO, a platform validation authority center (PVA) and a registration operator (RO), wherein:
the new SHO is configured to, receive parameters of the M2ME, and after verifying the M2ME by the PVA and the M2ME passes the verification, provide an MCIM of the new SHO to the M2ME through a connection between the M2ME and the RO provided by the old SHO or through a connection between the M2ME and the RO established by a trusted environment (TRE) functional entity;
the M2ME is configured to install the new MCIM in a universal integrated circuit card (UICC);
wherein, both the UICC and the TRE functional entity are located in the M2ME.

11. The system according to claim 10, wherein:
the new SHO is further configured to send the MCIM of the new SHO to the RO after verifying the M2ME by the PVA and the M2ME passes the verification;
the RO is configured to send the new MCIM to the M2ME through the connection provided by the old SHO;
the M2ME is further configured to delete information of the old SHO in the M2ME.

12. The system according to claim 10, wherein:
the RO is configured to activate the TRE functional entity in the M2ME after receiving information of the new SHO and the parameters of the M2ME sent by an M2ME subscriber; and, the RO is further configured to send the new MCIM to the M2ME through the connection established by the TRE functional entity;
the M2ME is further configured to establish the connection with the RO through the TRE functional entity, and, delete information of the old SHO in the M2ME;
the new SHO is further configured to authorize the RO to provide the MCIM of the new SHO after verifying the M2ME by the PVA and the M2ME passes the verification.

13. The system according to claim 10, wherein:
the RO is further configured to notify the old SHO that the M2ME changes the SHO after receiving information of the new SHO and the parameters of the M2ME sent by an M2ME subscriber; and, the RO is further configured to send the new MCIM to the M2ME through the connection established by the TRE functional entity;
the old SHO is configured to activate the TRE functional entity in the M2ME through an over the air (OTA) mode;
the M2ME is further configured to establish the connection with the RO through the TRE functional entity, and, delete information of the old SHO in the M2ME;
the new SHO is further configured to authorize the RO to provide the MCIM of the new SHO after verifying the M2ME by the PVA and the M2ME passes the verification.

14. The system according to claim 10, wherein:
the old SHO is configured to activate the TRE functional entity in the M2ME through an over the air (OTA) mode after receiving information of the new SHO and the parameters of the M2ME sent by an M2ME subscriber;
the M2ME is further configured to establish the connection with the RO through the TRE functional entity, and, delete information of the old SHO in the M2ME;
the new SHO is further configured to authorize the RO to provide the MCIM of the new SHO after verifying the M2ME by the PVA and the M2ME passes the verification;
the RO is configured to send the new MCIM to the M2ME through the connection established by the TRE functional entity.

15. The method according to claim 7, wherein,
in the step of the old SHO activating the TRE functional entity in the M2ME, the old SHO further deletes information of the old SHO in the M2ME at the same time; or,
after performing the step of the RO sending the new MCIM to the M2ME and before performing the step of the M2ME installing the new MCIM in the UICC, a step further performed is: the M2ME deleting information of the old SHO in the M2ME;
wherein, the information of the old SHO comprises the MCIM of the old SHO.

16. The method according to claim 5, wherein,
the step of the M2ME establishing the connection with the RO through the TRE functional entity and the RO registering the M2ME in the new SHO comprises:
the M2ME establishing an initial connection with a randomly selected visited network operator (VNO) through the TRE functional entity;
the VNO contacting with the RO, and sending a provisional connectivity identity (PCID) received from the M2ME to the RO;
the RO generating a set of authentication vectors regarding to the PCID, and sending to the VNO;
the VNO authenticating the PCID and the M2ME by using the authentication vectors, and after the authentication is passed, the VNO providing the M2ME with an IP connection to the RO;
the M2ME contacting with the RO through the IP connection provided by the VNO;
the RO discovering the new SHO for the M2ME, or, the M2ME discovering the new SHO through the RO;
the RO connecting with the new SHO, and registering the M2ME in the new SHO.

17. The method according to claim 6, wherein,
the step of the M2ME establishing the connection with the RO through the TRE functional entity and the RO registering the M2ME in the new SHO comprises:
the M2ME establishing an initial connection with a randomly selected visited network operator (VNO) through the TRE functional entity;
the VNO contacting with the RO, and sending a provisional connectivity identity (PCID) received from the M2ME to the RO;
the RO generating a set of authentication vectors regarding to the PCID, and sending to the VNO;
the VNO authenticating the PCID and the M2ME by using the authentication vectors, and after the authentication is passed, the VNO providing the M2ME with an IP connection to the RO;
the M2ME contacting with the RO through the IP connection provided by the VNO;
the RO discovering the new SHO for the M2ME, or, the M2ME discovering the new SHO through the RO;
the RO connecting with the new SHO, and registering the M2ME in the new SHO.

18. The method according to claim 7, wherein,
the step of the M2ME establishing the connection with the RO through the TRE functional entity and the RO registering the M2ME in the new SHO comprises:
the M2ME establishing an initial connection with a randomly selected visited network operator (VNO) through the TRE functional entity;
the VNO contacting with the RO, and sending a provisional connectivity identity (PCID) received from the M2ME to the RO;
the RO generating a set of authentication vectors regarding to the PCID, and sending to the VNO;
the VNO authenticating the PCID and the M2ME by using the authentication vectors, and after the authentication is passed, the VNO providing the M2ME with an IP connection to the RO;
the M2ME contacting with the RO through the IP connection provided by the VNO;
the RO discovering the new SHO for the M2ME, or, the M2ME discovering the new SHO through the RO;
the RO connecting with the new SHO, and registering the M2ME in the new SHO.
